(19) United States
(12) Patent Application Publication
(10) Pub. No.: US 2026/0187207 A1
(43) Pub. Date: Jul. 2, 2026

(54) TRACKING SOURCE OF REQUESTS FOR LDAP OPERATIONS

(71) Applicant: T-Mobile USA, Inc., Bellevue, WA (US)

(72) Inventor: Nandana T. Maddumakumara, Overland Park, KS (US)

(21) Appl. No.: 19/006,042

(22) Filed: Dec. 30, 2024

(51) Int. Cl. G06F 21/31

(52) U.S. Cl. CPC G06F 21/31

(57) ABSTRACT

The disclosed technology relates to methods and systems of modifying lightweight directory access protocol (LDAP) to enable association of requests for LDAP operation with corresponding LDAP clients that initiated the requests for LDAP operations by utilizing a unique identifier associated with the corresponding LDAP clients. Upon receiving a request for an LDAP operation, wherein the request includes a unique identifier corresponding to the LDAP client that sent the request, an LDAP server can be configured to associate the LDAP operation with the LDAP client based on comparing the unique identifier with one or more unique identifiers corresponding to multiple LDAP clients.

### BACKGROUND

Lightweight directory access protocol (LDAP) is an open, vendor-neutral, industry-standard application protocol for accessing and maintaining distributed directory information services over an internet protocol (IP) network. Directory services play an important role in developing intranet and internet applications by enabling sharing of information about users, systems, networks, services, and applications throughout the network.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flowchart representation of an example bind operation performed by an LDAP server upon a request by an LDAP client.

FIG. 4A illustrates an example structure of an LDAP bind request sent by an LDAP client to an LDAP server in accordance with one or more embodiments of the present technology.

FIG. 4B illustrates an example structure of an LDAP modify request sent by the LDAP client to the LDAP server following a successful LDAP bind request in accordance with one or more embodiments of the present technology.

FIG. 5 is a flowchart representation of an example process of modifying LDAP using a unique identifier in accordance with one or more embodiments of the present technology.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

LDAP is widely used for managing and accessing directory information in various information technology (IT) environments. One of the primary uses of LDAP is user authentication, wherein the protocol verifies user identities for access to systems and applications, ensuring secure login processes. LDAP directories also store information for email systems, such as user details and distribution lists. Additional use of LDAP includes network management through organization and control of access to network resources.

An LDAP bind request is a fundamental operation in LDAP used to authenticate a user to an LDAP server. The LDAP bind request establishes the identity of the user and sets security context for subsequent operations. Different types of LDAP bind requests include: 1) a simple bind involving sending a distinguished name (DN) and a password to the LDAP server; 2) an anonymous bind wherein clients do not provide any credentials; and 3) a Simple Authentication and Security Layer (SASL) bind to support various authentication mechanisms, such as Kerberos, DIGEST-MD5, and GSSAPI, and provide more secure and flexible authentication options. A typical LDAP bind request involves the user initiating a bind operation by sending the LDAP bind request to the LDAP server. After receiving the LDAP bind request, the LDAP server processes the LDAP bind request by verifying the credentials provided by the user against information saved in a directory. Subsequently, the LDAP server responds with a bind response indicating the result of the authentication attempt. If successful, the client is authenticated, and a session is established. If unsuccessful, the LDAP server returns an error message. Once authenticated, the user is enabled to send requests for LDAP operations to the LDAP server.

Currently, when the LDAP server receives requests for LDAP operations from multiple authenticated users, there is no way for the LDAP server to associate each request for LDAP operation with the authenticated user that sent the request. Associating the requests for LDAP operations with a corresponding LDAP client is critical in reconstructing a history of LDAP operations associated with the LDAP client, especially when the LDAP server identifies an issue associated with the LDAP client and needs to track the history of LDAP operations requested by the LDAP client. The technology disclosed herein relates to techniques for modifying the LDAP to enable association of the requests for LDAP operation with corresponding LDAP clients by utilizing a unique identifier associated with the corresponding LDAP clients. Upon receiving a request for an LDAP operation with an identifier corresponding to the LDAP client that sent the request, the LDAP server can be configured to associate the LDAP operation with the LDAP client based on comparing the unique identifier with one or more unique identifiers corresponding to multiple LDAP clients.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

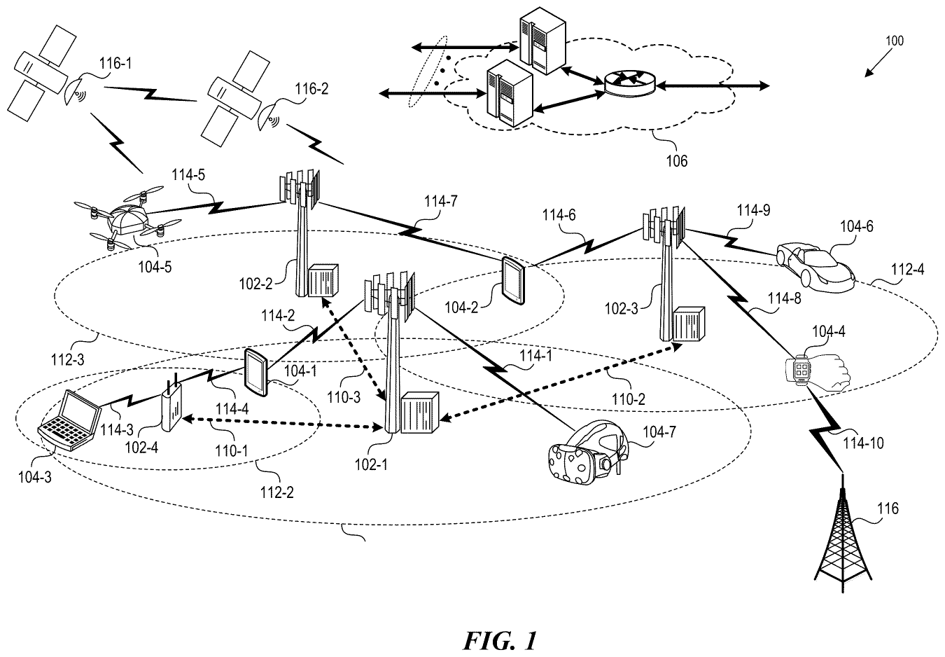

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

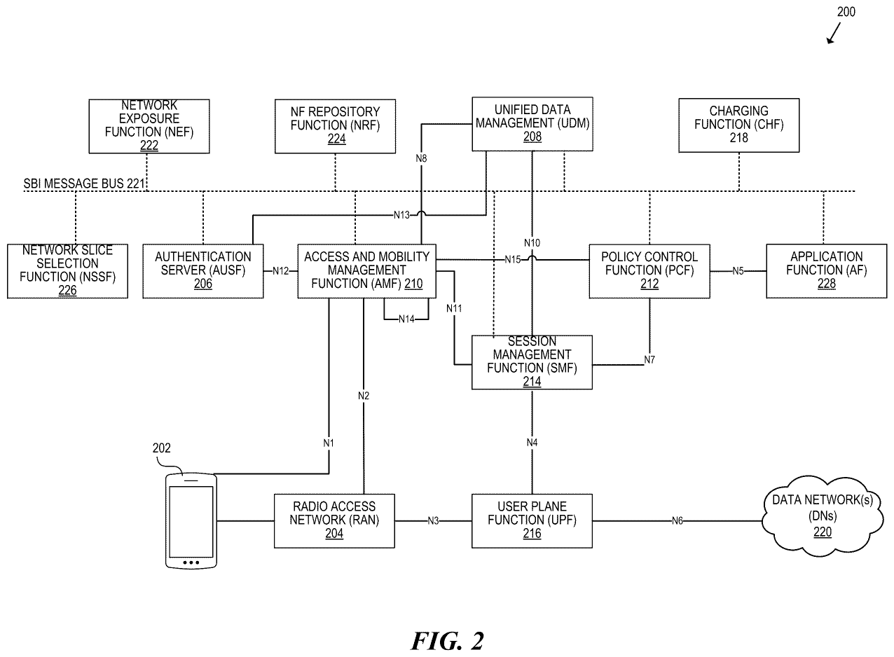

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Tracking Source of Requests for LDAP Operations

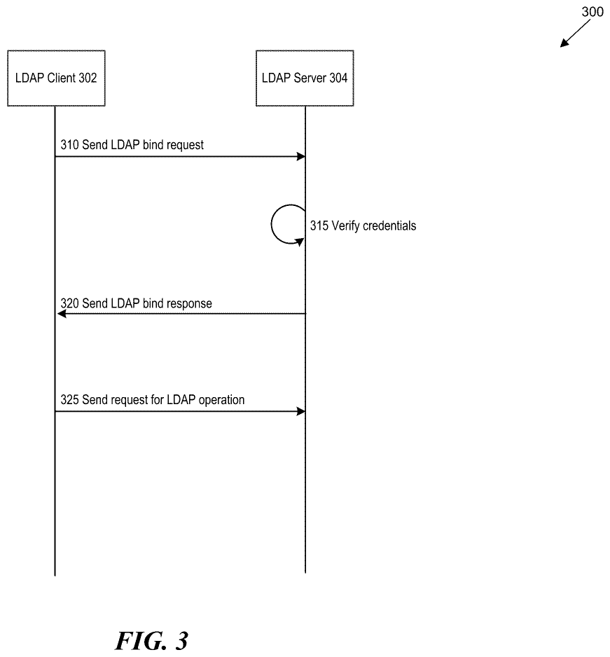

In LDAP, the function of a bind operation is to allow authentication information to be exchanged between a client and a server. FIG. 3 is a flowchart representation 300 of an example bind operation performed by an LDAP server 304 upon a request by an LDAP client 302.

In the example illustrated in FIG. 3, at Operation 310, the LDAP client 302 sends a bind request to the LDAP server 304. Fields of the bind request include a version number, name, and authentication. The version number indicates the version of the protocol to be used at the LDAP message layer. The LDAP client 302 sets the field to the version desired by the LDAP client 302, and the LDAP server 304 is unable to negotiate the version number. If the LDAP server 304 does not support the specified version, the LDAP server 304 responds with a bind response with a result code set to protocolError. The name field indicates the name of a directory object the LDAP client 302 desires to bind as. For anonymous binds or when using SASL authentication, the name field takes on a null value, which is a zero-length string. The authentication field includes information used in authentication, including the type of authentication. For anonymous authentications, which are typically used for operations that do not require authentication, no credentials are provided. For simple authentications, typically used for basic authentication scenarios where security requirements are minimal, a DN and a password for authentication are provided. For SASL authentication, which supports multiple authentication mechanisms including DIGEST-MD5, GSSAPI, or Transport Layer Security (TLS) client certificates, information needed for the corresponding authentication mechanism is included in the authentication field. If the LDAP server 304 does not support the authentication type requested by the LDAP client 302, the LDAP server 304 returns a bind response with the result code set to authMethodNotSupported.

At Operation 315, the LDAP server 304 processes the bind request and verifies the credentials provided by the LDAP client 302. Before processing a bind request, the LDAP server 304 is required to either complete or abandon all uncompleted operations. The LDAP client 302 may send multiple bind requests to change the authentication and/or security associations or to complete a multi-stage bind process. Similar to a single-step bind process, each step of the multi-step bind process requires the LDAP server 304 to return a bind response to indicate the status of authentication. When multiple bind requests are sent by the LDAP client 302, authentication from earlier bind requests is subsequently ignored.

At Operation 320, the LDAP server 304 sends an LDAP bind response indicating the status of the LDAP client 302's request for authentication. A successful bind operation is indicated by a bind response with a result code set to success. Otherwise, an appropriate result code indicating the authentication status is sent to the LDAP client 302.

Upon successful establishment of an LDAP session between the LDAP client 302 and the LDAP server 304, at Operation 325, the LDAP client 302 is enabled to send requests for LDAP operations to the LDAP server 304. The LDAP operations can include an unbind operation to terminate the LDAP session. The LDAP operations can also include a search operation, which is used to request the LDAP server 304 to return, subject to access controls and other restrictions, a set of entries matching a complex search criterion. The search operation can be used to read attributes from a single entry, from entries immediately subordinate to a particular entry, or from an entire subtree of entries. The LDAP operations can also include compare operation, add operation, delete operation, modify operation, or modify DN operation, which are each used to retrieve and/or make changes to attribute values in an entry. If the LDAP client 302 no longer needs the result of a previously initiated operation and desires to free up server resources, the LDAP client 302 may send a request for abandon operation to abandon an ongoing operation. The LDAP operations can also include extended operation, which allows for additional, custom operations that are not covered by the standard LDAP operations.

When the LDAP server 304 receives multiple requests for LDAP operations from multiple LDAP clients, the LDAP server 304 is unable to distinguish which LDAP client sent each of the multiple requests for LDAP operations. Associating the requests for LDAP operations with a corresponding LDAP client is critical in reconstructing a history of LDAP operations associated with the LDAP client, especially when the LDAP server identifies an issue associated with the LDAP client and needs to track the history of LDAP operations requested by the LDAP client.

This document discloses techniques that can be implemented in various embodiments to address the challenges in situations wherein the LDAP server receives multiple requests for LDAP operations from multiple LDAP clients and needs to track which LDAP client requested associated requests for LDAP operations.

The LDAP server can allocate a set of unique user identifiers for the LDAP clients. Upon receiving a bind request from an LDAP client, the LDAP server can assign a unique user identifier among the set of unique user identifiers to the LDAP client. Upon a successful establishment of a binding connection with the LDAP client, the LDAP server can transmit an LDAP bind response to the LDAP client. The LDAP bind response includes the unique user identifier associated with the LDAP client. Upon an unsuccessful establishment of a binding connection, the LDAP server transmits an LDAP bind response with a result code indicating an error that occurred during processing of the LDAP bind request.

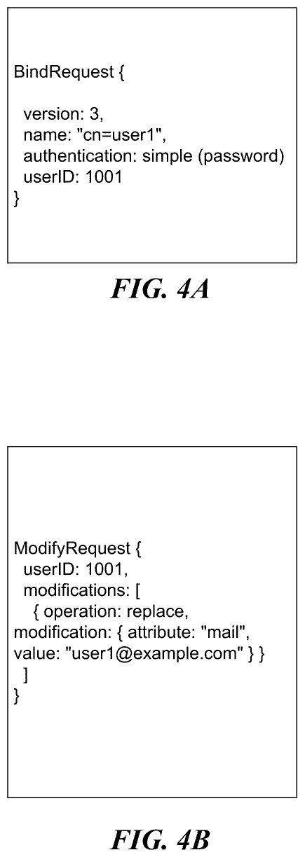

In some embodiments, the LDAP clients are aware of their respective unique identifiers and can inform the LDAP server in the bind request. FIG. 4A illustrates an example structure of an LDAP bind request sent by an LDAP client to an LDAP server in accordance with one or more embodiments of the present technology. The LDAP bind request as illustrated in FIG. 4A indicates that version 3, or LDAPv3, is used at the LDAP message layer between the LDAP client and the LDAP server. The LDAP bind request also indicates a DN with which the LDAP client wishes to bind to the LDAP server. The DN can be broken down as a common name attribute with value “user1,” a domain component attribute with value “example,” and another domain component attribute with value “com.” The LDAP bind request also indicates that the type of authentication to be used is simple authentication. In some implementations the LDAP bind request includes a password to be used for authentication. In addition to the above fields, the LDAP bind request as illustrated in FIG. 4A includes an additional field called userID with value “1001,” which can be an identifier corresponding to the LDAP client. The userID can be a unique identifier that is assigned by the LDAP server to each of the LDAP clients. Upon establishing a binding connection with the LDAP client, the LDAP server can transmit the userID or any unique identifier associated with the LDAP client in an LDAP bind response to the LDAP client. Alternatively, the userID can be existing identifiers such as International Mobile Equipment Identity (IMEI), Unique Device Identifier (UDID) for Apple devices, Android ID for Android devices, Medium Access Control (MAC) Address, and/or serial number associated with each of the LDAP clients.

FIG. 4B illustrates an example structure of an LDAP modify request sent by the LDAP client to the LDAP server following a successful LDAP bind request in accordance with one or more embodiments of the present technology. As illustrated, the LDAP modify request is accompanied by the userID identifying the LDAP client that sent the LDAP modify request. The inclusion of the field userID enables the LDAP server to associate any requests for LDAP operation with the LDAP client that initiated the requests. The LDAP modify request as illustrated in FIG. 4B is a request to replace an entry with an attribute of “mail” with “user1@example.com.” The inclusion of userID is not limited to LDAP modify requests; requests for other LDAP operations, such as UnbindRequest, SearchRequest, ModifyRequest, AddRequest, DelRequest, CompareRequest, AbandonRequest, or ExtendedRequest, can also include the additional field of userID such that the requests for the LDAP operations can be associated with the LDAP client and enable the LDAP server to determine which LDAP client sent each request for LDAP operations when the LDAP server receives multiple requests from multiple LDAP clients. The additional field enables the LDAP server to distinguish requests from multiple LDAP clients with the same source port and destination port.

Associating each request for LDAP operation with the LDAP client that initiated the request is important when the LDAP server identifies an issue associated with the LDAP client. Upon identification of such issue associated with the LDAP client, the LDAP server can trace the signaling messages using the client identifier associated with the LDAP client or reconstruct a history of LDAP operations associated with the LDAP client by performing a search of past LDAP operations using the unique identifier associated with the LDAP client. The search using the unique identifier eliminates the need to manually analyze each log to identify the LDAP client that sent each request for LDAP operations.

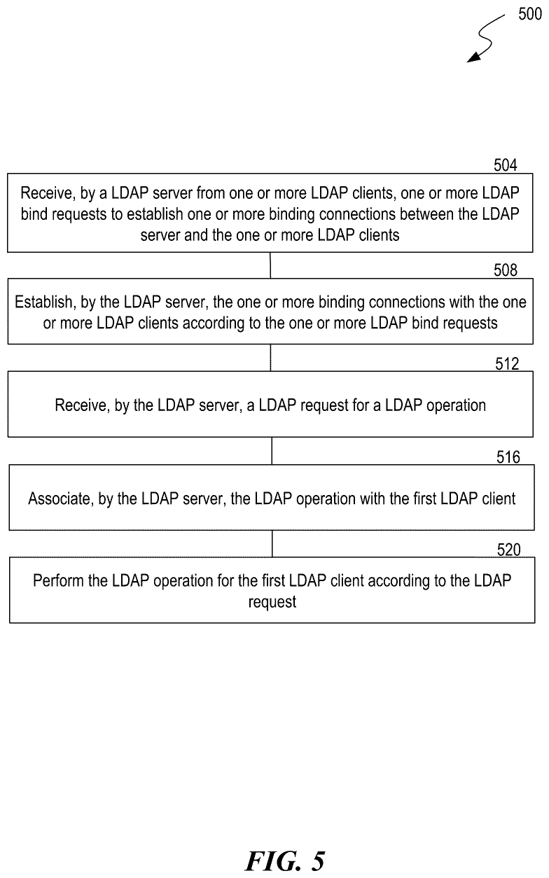

FIG. 5 is a flowchart representation of an example process 500 of modifying LDAP using a unique identifier in accordance with one or more embodiments of the present technology. Other implementations of the process 500 include additional, fewer, or different network components and/or additional, fewer, or different steps or involve performing the steps in different orders.

At Operation 504, an LDAP server receives, from one or more LDAP clients, one or more LDAP bind requests to establish one or more binding connections between the LDAP server and the one or more LDAP clients. The one or more LDAP bind requests can be a simple bind request. The function of the one or more LDAP bind requests is to allow authentication information to be exchanged between the one or more LDAP clients and the LDAP server. The one or more LDAP bind requests include multiple fields, including, but not limited to, a version number indicating the version of the protocol to be used, a name of a directory object the LDAP client wishes to bind as, information used in authentication, and a unique identifier associated with the LDAP client. The unique identifier can be assigned to the one or more LDAP clients by the LDAP server. Alternatively, the unique identifier can comprise an existing identifier associated with the one or more LDAP clients, such as an International Mobile Equipment Identity (IMEI) of each of the one or more LDAP clients.

At Operation 508, the LDAP server establishes the one or more binding connections with the one or more LDAP clients according to the one or more LDAP bind requests. Upon a successful establishment of a binding connection, the LDAP server transmits an LDAP bind response to the corresponding LDAP client, wherein the LDAP bind response includes the unique identifier associated with the LDAP client. Upon an unsuccessful establishment of a binding connection, the LDAP server transmits an LDAP bind response with a result code indicating an error that occurred during processing of the LDAP bind request.

At Operation 512, the LDAP receives an LDAP request for an LDAP operation. The LDAP request originates from one or more LDAP clients that successfully established a binding connection with the LDAP server. The LDAP request for LDAP operation can include an unbind request, search request, modify request, add request, delete request, compare request, abandon request, or extend request. The LDAP operations are operations that enable the LDAP clients to interact with a directory server. The LDAP request for LDAP operation includes the unique identifier corresponding to the LDAP client that initiated the LDAP request for LDAP operation.

At Operation 516, the LDAP server associates the LDAP operation with the LDAP client that initiated the request based on comparing the unique identifier of the LDAP client with one or more unique identifiers corresponding to the one or more LDAP clients. Based on the comparison, the LDAP server determines which LDAP client initiated the LDAP request for the LDAP operation.

At Operation 520, the LDAP server performs the LDAP operation for the corresponding LDAP client according to the LDAP request. Following a successful LDAP operation, the LDAP server may or may not generate a response, depending on the type of LDAP operation performed. For an LDAP request to unbind, the LDAP server terminates a session between the LDAP server and the corresponding LDAP client and does not generate a response. Similarly, for an LDAP request to abandon, the LDAP server cancels the ongoing operation and does not generate a response. For other LDAP operations, such as search, compare, add, delete, modify, or extend, the LDAP server generates a response indicating the result of the request for LDAP operation. The response can include the unique identifier associated with the corresponding LDAP client.

In some implementations, the LDAP server identifies an issue associated with a particular LDAP client. Upon identification of such issue, the LDAP server can reconstruct a history of LDAP operations associated with the LDAP client, including the initial bind operation, by performing a search of past LDAP operations using the unique identifier associated with the LDAP client.

### Computer System

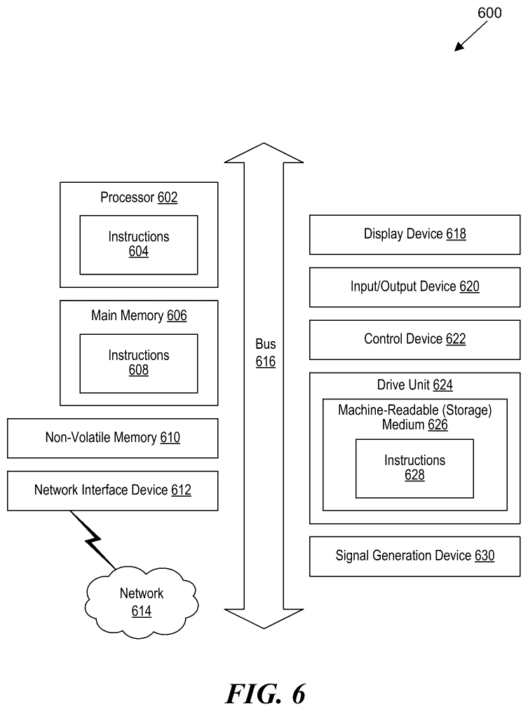

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for a lightweight directory access protocol (LDAP), the method comprising:
receiving, by an LDAP server from one or more LDAP clients, one or more LDAP bind requests to establish one or more binding connections between the LDAP server and the one or more LDAP clients;
establishing, by the LDAP server, the one or more binding connections with the one or more LDAP clients according to the one or more LDAP bind requests,
wherein the one or more LDAP clients are associated with one or more unique identifiers, each corresponding to an LDAP client;
receiving, by the LDAP server, an LDAP request for an LDAP operation,
wherein the LDAP request includes a first identifier corresponding to a first LDAP client in the one or more LDAP clients;
associating, by the LDAP server, the LDAP operation with the first LDAP client based on comparing the first identifier with the one or more unique identifiers associated with the one or more LDAP clients; and
performing the LDAP operation for the first LDAP client according to the LDAP request.

2. The method of claim 1, further comprising:
identifying an issue associated with the first LDAP client; and
upon identification of the issue associated with the first LDAP client, reconstructing a history of LDAP operations associated with the first LDAP client by performing a search of past LDAP operations using the first identifier corresponding to the
first LDAP client.

3. The method of claim 1, wherein each of the one or more LDAP bind requests includes a unique identifier corresponding to each of the one or more LDAP clients.

4. The method of claim 3, wherein the unique identifier comprises an International Mobile Equipment Identity (IMEI) of each of the one or more LDAP clients.

5. The method of claim 1, further comprising:
assigning, by the LDAP server, a unique identifier for each of the one or more LDAP clients; and
transmitting, by the LDAP server, the unique identifier in an LDAP bind response to an LDAP client upon establishing a binding connection with the LDAP client.

6. The method of claim 1, wherein the LDAP operation comprises at least one of: UnbindRequest, SearchRequest, ModifyRequest, AddRequest, DelRequest, CompareRequest, AbandonRequest, or ExtendedRequest.

7. The method of claim 1, wherein each of the one or more LDAP bind requests is a simple bind request.

8. A non-transitory, computer-readable storage medium comprising instructions recorded thereon, wherein the instructions, when executed by at least one data processor of a system, cause the system to:
receive, from one or more LDAP clients, one or more LDAP bind requests to establish one or more binding connections between an LDAP server and the one or more LDAP clients;
establish the one or more binding connections with the one or more LDAP clients according to the one or more LDAP bind requests,
wherein the one or more LDAP clients are associated with one or more unique identifiers, each corresponding to an LDAP client;
receive an LDAP request for an LDAP operation,
wherein the LDAP request includes a first identifier corresponding to a first LDAP client in the one or more LDAP clients;
associate the LDAP operation with the first LDAP client based on comparing the first identifier with the one or more unique identifiers associated with the one or more LDAP clients; and
perform the LDAP operation for the first LDAP client according to the LDAP request.

9. The non-transitory, computer-readable storage medium of claim 8, wherein the instructions further cause the system to:
identify an issue associated with the first LDAP client; and
upon identification of the issue associated with the first LDAP client, reconstruct a history of LDAP operations associated with the first LDAP client by performing a search of past LDAP operations using the first identifier corresponding to the first LDAP client.

10. The non-transitory, computer-readable storage medium of claim 8, wherein each of the one or more LDAP bind requests includes a unique identifier corresponding to each of the one or more LDAP clients.

11. The non-transitory, computer-readable storage medium of claim 10, wherein the unique identifier comprises an International Mobile Equipment Identity (IMEI) of each of the one or more LDAP clients.

12. The non-transitory, computer-readable storage medium of claim 8, wherein the instructions further cause the system to:
assign a unique identifier for each of the one or more LDAP clients; and
transmit the unique identifier in an LDAP bind response to an LDAP client upon establishing a binding connection with the LDAP client.

13. The non-transitory, computer-readable storage medium of claim 8, wherein the LDAP operation comprises at least one of: UnbindRequest, SearchRequest, ModifyRequest, AddRequest, DelRequest, CompareRequest, AbandonRequest, or ExtendedRequest.

14. The non-transitory, computer-readable storage medium of claim 8, wherein each of the one or more LDAP bind requests is a simple bind request.

15. A system for modifying lightweight directory access protocol (LDAP), the system comprising:
at least one hardware processor; and
at least one non-transitory memory storing instructions, which, when executed by the at least one hardware processor, cause the system to:
receive, from one or more LDAP clients, one or more LDAP bind requests to establish one or more binding connections between an LDAP server and the one or more LDAP clients;
establish the one or more binding connections with the one or more LDAP clients according to the one or more LDAP bind requests,
wherein the one or more LDAP clients are associated with one or more unique identifiers, each corresponding to an LDAP client;
receive an LDAP request for an LDAP operation,
wherein the LDAP request includes a first identifier corresponding to a first LDAP client in the one or more LDAP clients;
associate the LDAP operation with the first LDAP client based on comparing the first identifier with the one or more unique identifiers associated with the one or more LDAP clients; and
perform the LDAP operation for the first LDAP client according to the LDAP request.

16. The system of claim 15, wherein the instructions further cause the system to: identify an issue associated with the first LDAP client; and
upon identification of the issue associated with the first LDAP client, reconstruct a history of LDAP operations associated with the first LDAP client by performing a search of past LDAP operations using the first identifier corresponding to the first LDAP client.

17. The system of claim 15, wherein each of the one or more LDAP bind requests includes a unique identifier corresponding to each of the one or more LDAP clients.

18. The system of claim 17, wherein the unique identifier comprises an International Mobile Equipment Identity (IMEI) of each of the one or more LDAP clients.

19. The system of claim 15, wherein the instructions further cause the system to:
assign a unique identifier for each of the one or more LDAP clients; and
transmit the unique identifier in an LDAP bind response to an LDAP client upon establishing a binding connection with the LDAP client.

20. The system of claim 15, wherein the LDAP operation comprises at least one of: UnbindRequest, SearchRequest, ModifyRequest, AddRequest, DelRequest, CompareRequest, AbandonRequest, or ExtendedRequest.
